(19) United States
(12) Patent Application Publication
(10) Pub. No.: US 2018/0072555 A1
(43) Pub. Date: Mar. 15, 2018

(54) Systems And Methods Of Custom Dispensing

(71) Applicant: Cornelius, Inc., St. Paul, MN (US)

(72) Inventors: Nancy Fortunato, Wauconda, IL (US); Loren Veltrop, Chicago, IL (US); Elizabeth Bertness, Batavia, IL (US); Donald Sweeney, St. Charles, IL (US); Glenn Schackmuth, Oswego, IL (US)

(73) Assignee: Cornelius, Inc., St. Paul, MN (US)

(21) Appl. No.: 15/698,164

(22) Filed: Sep. 7, 2017

Related U.S. Application Data
(60) Provisional application No. 62/393,370, filed on Sep. 12, 2016.
(60) Provisional application No. 62/423,029, filed on Nov. 16, 2016.
(60) Provisional application No. 62/516,954, filed on Jun. 8, 2017.
(60) Provisional application No. 62/423,012, filed on Nov. 16, 2016.

(51) Int. Cl. B67D 7/02

(52) U.S. Cl. CPC B67D 7/02; A23L 27/20

(57) ABSTRACT

Systems and methods of custom dispensing present a plurality of custom dispense options to a user. At least one user selection is received. A recipe ID representative of the at least one selection is created. The at least one selection of the custom dispense is dispensed. The custom dispense options may include a flavoring, a conduit, or a size of a dispense. A recipe ID may be encoded in an image including a bar code or quick response code. The recipe ID may facilitate communication between a point-of-sale system and a dispenser.

### CROSS REFERENCE TO RELATED APPLICATION

The present application claims priority of U.S. Provisional Patent Application Nos. 62/393,370, filed on Sep. 12, 2016, 62/423,012, filed on Nov. 16, 2016, 62/423,029, filed on Nov. 16, 2016, and U.S. Provisional Patent Application No. 62/516,954, filed on Jun. 8, 2017, the contents of which are hereby all incorporated herein by reference in their entireties.

### BACKGROUND

As restaurant, concession, and vending services move towards increased customized product offerings and consumers look for a more personalized food experience, vendors are looking for new ways to incorporate these trends. Dispensers for custom condiments, sauces, flavors, and/or other additives are desirable in the field. However for these dispensers to be widely accepted, the dispensers should be intuitive and easy to use. This intuitive and easy use applies to both customer-facing dispensers and to worker-facing or “behind-the-counter” dispensers. While user interface embodiments can improve ease of use, other manners of information transfer may be desired to provide a custom dispenser that quickly and accurately dispenses custom substances requested by a customer.

### BRIEF DISCLOSURE

An exemplary embodiment of a method of dispensing flavoring presents a plurality of flavoring options on a user interface of the dispenser. A selection of at least one flavoring option of the plurality of flavoring options is received. A recipe ID representative of the selected at least one flavoring option is created. The selected at least one flavoring option is dispensed.

An exemplary embodiment of a condiment dispenser includes a graphical display operable to visually present a graphical user interface (GUI). The graphical user interface presents a plurality of custom dispense options including a plurality of base sauces. A processor operates the graphical display to visually present the GUI. The processer receives a user selection of at least on custom dispense option the process creates a recipe ID representative of the user selection of at least one custom dispense option. The processor operates the graphical display to visually present the recipe ID in the GUI. A dispensing system includes at least one nozzle. The dispensing system is operated by the processor to dispense a portion of the custom edible substance with the selected at least one custom dispense option out of the at least one nozzle.

A third exemplary embodiment of a custom edible substance dispensing system includes a point of sale (POS) system that includes a user interface. A user enters a custom order comprising an edible substance with at least one custom dispense option. The POS system encodes the custom order as a recipe ID. A dispenser includes a processor. The processor receives a user selection of the custom order comprising at least one custom dispense option by receiving the recipe ID. A dispensing assembly includes a plurality of reservoirs containing edible substance. The dispensing assembly further includes at least one nozzle. The dispensing assembly is operated by the processor to dispense portions of the edible substance of the custom order out of the at least one nozzle. A conveyance device is communicatively connected to the POS system. The conveyance device facilitates transfer of the recipe ID from the POS to the dispenser.

### BRIEF DESCRIPTION OF THE DRAWINGS

FIG. 1 depicts an exemplary embodiment of a custom dispenser.

FIG. 2 is a system diagram that depicts an exemplary embodiment of a custom dispensing system.

FIG. 3 is a system diagram of an exemplary embodiment of a custom dispensing system.

FIG. 4 is an exemplary embodiment of a user interface for a custom condiment dispenser.

FIG. 5 is a further exemplary embodiment of a user interface for a custom condiment dispenser.

FIG. 6 is an exemplary embodiment of a user interface for a custom flavoring dispenser.

FIGS. 7A-7D depict exemplary embodiments of user interfaces for a custom dispenser.

FIG. 8 exemplarily depicts a mobile device with an exemplary embodiment of an app screen shot.

FIG. 9 exemplarily depicts a screen shot of a social media post.

FIG. 10 is a flow chart that depicts an exemplary embodiment of a method of custom condiment dispensing.

FIG. 11 depicts an exemplary embodiment of ordering in a drive-through environment.

FIGS. 12A and 12B depict an exemplary embodiment of a user inputting a customer order using a barcode on a mobile computing device.

FIG. 13 is an exemplary embodiment of a user interface for a custom flavoring dispenser.

### DETAILED DISCLOSURE

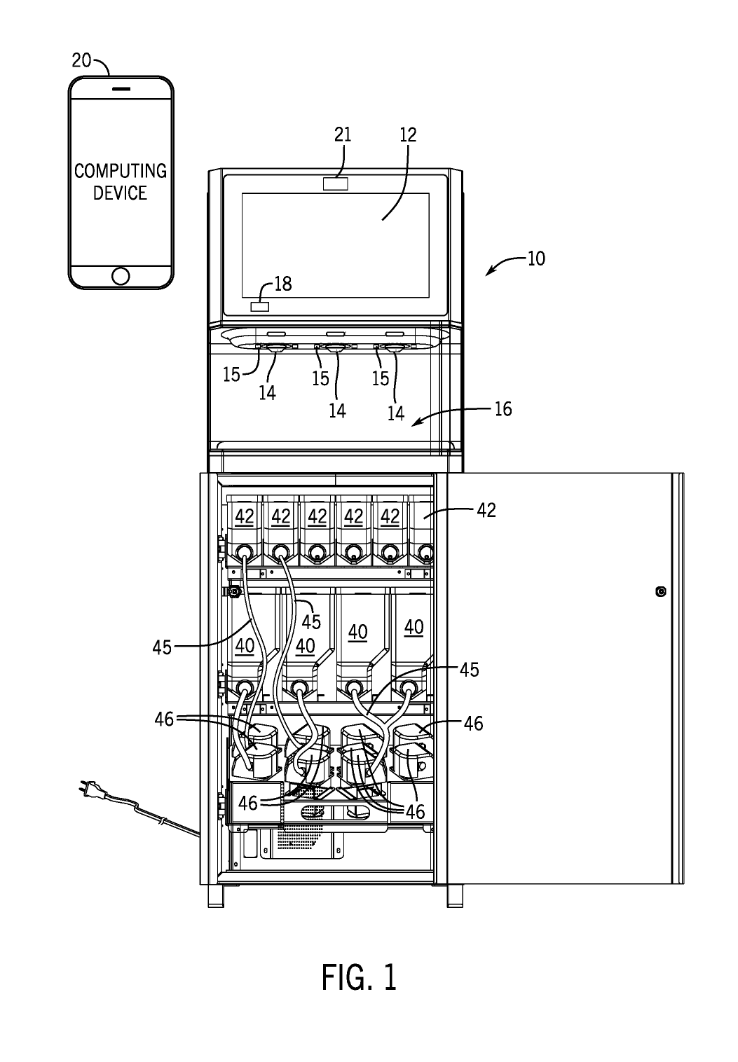

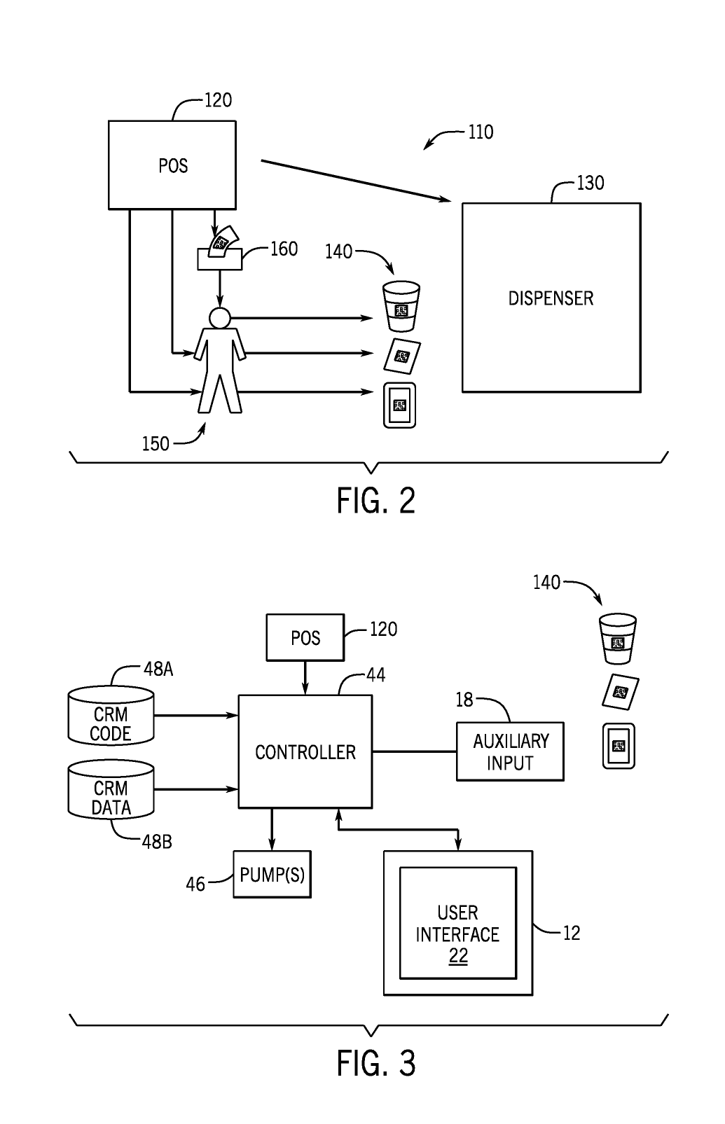

FIG. 1 depicts an exemplary embodiment of a custom dispenser 10. In an exemplary embodiment, the custom dispenser 10 is a dispenser of custom condiments, while in another embodiment, the custom dispenser dispenses custom flavoring, additives, or toppings for a beverage or a food. FIG. 2 is a system diagram of an exemplary embodiment of the custom dispenser 10. The custom dispenser 10 exemplarily includes a graphical display 12, which may also function as a user input device in exemplary embodiments of which will be described in further detail herein. FIG. 3 depicts an exemplary embodiment of a user interface 22 as may be presented on the graphical display 12. The graphical display 12 is exemplarily a touch screen graphical display that is operable as a user interface, although it will be recognized that in other embodiments, other forms of user interfaces including but not limited to physical keyboards, gesture, as well as wireless embodiments including WI-FI and/or BLUETOOTH protocols for communication with a smart phone or other handheld wireless device may be used.

The custom dispenser 10 further includes at least one nozzle 14 through which the custom substance is dispensed into a dispensing area 16 in which the user may place a receptacle such as a cup, a portion cup, a food item, or a refillable bottle. The custom dispenser 10 operates to dispense a portion of a requested created custom substance into the receptacle. Embodiments as disclosed herein may include a nozzle 14 which mixes constituent components in the nozzle, or the nozzle may dispenser individual streams of constituent components. In still further embodiments, the nozzle may dispense a substance that has already been mixed from component ingredients prior to exiting the nozzle. In still further embodiments, the nozzle 14 may be a centralized location about outlets for tubes dispensing various constituent flavorings.

It will be recognized that embodiments of the custom dispenser 10 may operate in a variety of ways to dispense various types of custom substances while remaining within the scope of the present disclosure. In embodiments, the dispenser 10 may include a plurality of reservoirs. In the embodiment of a custom dispenser depicted in FIG. 1 used to dispense custom condiments, the custom dispenser 10 may include base condiment reservoirs 40, for example, but not limited to reservoirs 40 for ketchup, barbecue sauce, and/or ranch dressing. The custom dispenser 10 includes flavoring reservoirs 42. As will be described in further detail herein, the flavorings contained within the flavoring reservoirs 42 and used by the dispenser 10 may take a variety of forms including, but not limited to liquid concentrated flavoring, granular flavoring, or a concentrated flavoring sauce. It is understood that the flavoring reservoirs 42 may be adapted to contain and dispense a particular type of flavoring. Upon user operation of the user interface presented on the graphical display 12 to select a custom condiment to dispense, a controller 44 operates the custom dispenser 10 to dispense the combination of the base condiment and at least one of the appropriately selected flavorings to produce the selected custom condiment. In other embodiments, the custom condiment dispenser may include receptacles (not depicted) containing a variety of premixed condiment flavor from which a user may select as described herein. Upon selection by user, the custom dispenser 10 operates to dispense a portion of the selected condiment from the appropriate receptacle(s) through one or more nozzles 14.

Each of the reservoirs 40, 42 are exemplarily connected to pumps 46 which respectively operate to selectively pump the base condiments and flavorings to the nozzle 14. In an exemplary embodiment a flexible tube 45 may connect each of the reservoirs 40, 42 to at least one of the pumps 46. Only some flexible tubes 45 are depicted in FIG. 1 for simplification, although it will be recognized that each reservoir 40, 42 may be connected to one or more flexible tubes 45. In exemplary embodiments, the pumps 46 are peristaltic pumps that operate to push the base condiment and or flavoring through the respective tubes. The pumps 46 may also be any of gravity feed, pressurization, electromechanical, or other dispensing techniques as will be recognized by a person of ordinary skill in the art in view of the present disclosure. The flexible tubes 45 exemplarily extend through the pumps 46 and prevent the pumps 46 from being in contact with the food flowing through the flexible tubes 45, e.g. the base condiment or flavoring. While not depicted in FIG. 1, the flexible tubes 45 further extend through the pumps 46 to the nozzles 14 for dispense of the condiment and/or flavoring.

In a non-limiting embodiment, reservoir 40 is filled with ketchup while another condiment reservoir 40 is filled with ranch dressing. In other exemplary and non-limiting embodiments, barbeque sauce or mayonnaise may be the base condiments in one of the condiment reservoirs 40. Flavoring reservoirs 42 are exemplarily filled with flavorings of different flavors and may be connected to multiple nozzles 14 in embodiments where the dispenser 14 has multiple nozzles. In a multiple-nozzle embodiment, each nozzle may be associated with dispense of a different base condiment. In a single nozzle embodiment, all base condiments and/or flavorings may be routed through the single nozzle.

While the reservoirs 40, 42 depicted in FIG. 1 are depicted as refillable and reusable containers, it will be recognized that other embodiments may use any of a wide variety of reservoirs. Alternative examples of reservoirs may include, but are not limited to, disposable packaging such as bags, boxes, and bag-in-box packaging. Still further examples of reservoirs may include movable or removable lids to facilitate refilling of reservoirs with additional base condiment or flavoring. In still further examples, the reservoirs may be fillable through an opening with a removable cap, for example a removable cap which facilitates connection of the reservoir to the condiment dispenser. The connections between the reservoirs 40, 42 and the flexible tubes 45 may comprise a two-part connector with ends secured to the flexible tubes 45 designed to mate with a cap or cover of a reservoir to provide a secure connection. In a still further embodiment, particular flexible tubes 45 and reservoirs 42 may be keyed such that the flexible tubes 45 are reconnected only to an associated reservoir such as to avoid cross-contamination of the flavorings, or to ensure that each flavoring line in the custom condiment dispenser carries the expected flavoring.

In the present disclosure, the examples of base condiments of ketchup, ranch dressing and barbeque sauce will be used for exemplary purposes, although it will be recognized by a person of ordinary skill in the art that other condiments, including, but not limited to mustard, mayonnaise, melted or liquid butter, olive oil, melted or liquid cheese sauce, yogurt, ranch, guacamole, sour cream, chili, and/or tartar sauce may be used. In addition to the above savory foods, sweet foods for example sauces, syrups, and other toppings for example chocolate, butterscotch, caramel, and strawberry may be dispensed in other embodiments. In still further embodiments, liquids, for example milk, skim milk, cream, half and half, soy milk, or non-dairy flavored creamer may be dispensed.

In non-limiting examples, flavorings such as sriracha, buffalo, jalapeno, teriyaki, honey, onion, garlic, bacon, oak, soy sauce, smoke, pepper, vinegar, pickle, chili, mint, chocolate, caramel, pumpkin spice, vanilla, egg nog, citrus, peppermint, basil, and/or wasabi may be used although it will be recognized that these examples of flavorings are again merely exemplary of possible flavors and are not intended to be limiting on the scope of flavors that may be provided in a custom condiment dispenser in either of liquid, granular or flavored sauce form. Granular substances may include sugar, cinnamon, powdered non-dairy creamer, crushed candy, or colored or other decorative granules. In a still further embodiment, whip cream or flavored whip cream may be dispensed.

While guacamole and tarter were exemplarily identified above as examples of base condiments, it may also be recognized that those sauces may exemplarily be produced as custom condiments when other base sauces are used in combination with further examples of flavorings. For example in the case of guacamole, a base condiment of sour cream may be combined with avocado and onion and/or jalapeno to produce guacamole. While tarter sauce may be produced by a combination of a base condiment of mayonnaise with onion and pickle relish flavorings.

As previously noted, the flavorings may come in a variety of forms. In one exemplary embodiment, the flavorings are a concentrated liquid flavoring. Such concentrated liquid flavorings may be nutritive in nature and may be exemplarily water, alcohol, or oil based and potentially highly concentrated and therefor may require volumetrically a small amounts of the flavoring to achieve the custom condiment. In exemplary embodiments, a dispense of liquid flavoring may be between 0.8 mL and 1.2 mL. In other embodiments, each constituent flavoring in the dispense may be between 0.8 mL and 1.2 mL. In other embodiments, the dispense volume may be between 1.0 mL and 0.15 mL. In other embodiments, a single dispense may contain about 0.5 mL of flavoring, while constituent flavoring in the dispense may be as little as 0.15 mL. In such embodiments, the flavoring reservoirs and associated pumps may be comparatively small to handle these volumes.

In another embodiment, the flavoring may be in the form of a flavored sauce. Exemplarily, the flavored sauce may be a liquid starch sauce that carries the flavoring. This increases the volume of the flavoring which can promote mixing of the custom condiments in embodiments as disclosed in further detail herein. In further exemplary embodiments, the carrier sauce may be mixed with varying concentrations of the flavoring to produce different intensities of flavor for custom condiments further as described herein. In still further embodiments as discussed herein, only flavorings or combinations of flavorings may be dispensed, for example into an empty receptacle or a receptacle of a beverage or food.

In still further exemplary embodiments, the flavoring may be granular or powdered in form and in exemplary embodiments may use a gravity fed system as opposed to the disclosed pumping system as described for use with liquid and/or flavored sauce embodiment.

The custom dispenser 10, further exemplarily includes a proximity sensor 21 located at a front of the device, exemplarily near the graphical display 12. Signals from the proximity sensor 21 may exemplarily be used to switch a mode of operation of the custom dispenser 10 for example from a resting mode to a dispensing mode. In a resting mode, the graphical display 12 may be operated to exemplarily present advertisements, pictures, video, or text. In a dispensing mode, the graphical display 12 may be operated as disclosed in further detail herein to present a user interface for the operation and control of the custom dispenser 10.

The custom dispenser 10 may further include one or more proximity sensors 15 located relative to the nozzles 14. In embodiments, these proximity sensors 15 may be used to coordinate and/or trigger the dispense. In one embodiment, both a sensed proximity of a receptacle relative to the nozzle 14 and a user input exemplarily a selection of a dispense button on the graphical display 12 is coordinated for the dispenser 10 to perform the requested dispense. In other embodiments as disclosed herein, the custom order is received by the dispenser 10 and automatedly loaded therein and upon sensing the proximity of the receptacle relative to the nozzle commences the dispense into the receptacle without further user input, for example by way of the user interface.

As described in further detail herein, the custom condiment dispenser 10 further includes an auxiliary input device 18 which may exemplarily be a bar code reader, or more specifically a two dimensional bar code reader, for example a quick response (QR) code reader, although in other embodiments, may be an infrared, wireless, or wired communication connection. In either event, the auxiliary input device 18 facilitates a communicative connection with printed media or a computing device 20, for example, a smartphone. In embodiments, the computing device 20 may be used in whole or in part by the user to input the selected custom condiment rather than, or in addition to, interaction with the user interface 12. It will be recognized that in other embodiments described herein, particularly embodiments where the custom condiment dispenser 10 is configured for use by a food service or food preparation worker, the printed media or computing device 20 may be a computer, tablet computer, or other device communicatively connected at the auxiliary input device 18 providing instructions to the custom condiment dispenser 10. In these embodiments, the computing device 20 may be a point of sale (POS) system that manages orders and/or order fulfillment.

In still further embodiments, QR codes or other bar codes as read by the auxiliary input device 18 can be used to carry out other functions of the custom condiment dispenser 10. This can include set-up, maintenance, cleaning, or service functions. These exemplary QR codes may be stored or generated on a mobile computing device of a service technician or person tasked with cleaning the device. In other embodiments, one or more QR codes may be provided in a maintenance manual for the custom condiment dispenser.

FIG. 2 depicts an exemplary embodiment of a point of sale (POS) and delivery system 110. The POS and delivery system 110 exemplarily includes three components—POS system 120, a dispenser 130, and a conveyance device 140. In embodiments of the POS and delivery system 110 the system may use internet of things (IOT) to communication and coordination between components, for example an ordering kiosk, and information server, and one or more dispensers. In embodiments as disclosed herein a custom condiment, sauce, additive, or flavoring may be ordered and dispensed based upon communication between either the POS system 120 and the dispenser 130, the conveyance device 140 and the dispenser 130 or communication between all three. The dispenser 130 is exemplarily a dispenser as shown and described above with respect to FIG. 1, as well as other dispensers as recognized by a person of ordinary skill in the art in view of the present disclosure.

As used herein, the POS system encompasses other similar systems including restaurant management systems (RMS). In general terms, the POS system 120 as used herein operates to receive customer orders and control through information management and data communication systems the documentation of the order and transmit that order or portions of the order to various components or devices within the restaurant and/or to provide visual presentation of the customers' orders to workers of the restaurant so that completion of preparation and assembly of customer orders can be viewed and understood by restaurant managers and/or workers. The POS system may be implemented across multiple devices which may be communicatively connected via a communications network to one or more information servers upon which the restaurant and order information may be stored. One or more of the components of the POS system may be remotely located from the kitchen of the restaurant, for example in another area of the building, or may be located remotely to the restaurant itself, for example, in a cloud or internet based implementation. In two exemplary embodiments as will be used in the present disclosure, the customer orders may be received into the POS system either by a remote customer order either through a computer or a mobile computing device app or the customer order may be entered into a user interface either by a restaurant worker or by the customer in a self-help implementation.

In an exemplary “vending machine” configuration, the dispenser 130 itself is configured to accept payment, particularly in the form of a credit card or (coin or paper) money. Payments may be made electronically, for example through the use of a smart phone. The customer either prepays to unlock the interface for the dispenser, or the customer pays after the custom substance is selected, but before the dispenser is activated to dispense the requested substance. The customer may also select a substance for no charge and pay to add additional substances. In such an embodiment, the transaction is handled by and within the dispenser 30. In one such embodiment, the dispenser may also be configured to dispense a beverage and also dispense the requested substance into or combined with the requested beverage.

However, in other embodiments it is desirable to provide a communicative link between at least one other component of the system 110 and the dispenser 130, to provide a further coordinated dispense experience within the system and to control use of the dispenser 130 without taking payments directly at the dispenser 130. In an exemplary embodiment, this can facilitate payment and authorization within the system, but remove the payment component from the interaction with the dispenser itself, thus making the dispensing interaction by the customer faster and more efficient.

In an exemplary embodiment, the conveyance device 140 is used to interact with the dispenser 130. In the present disclosure, conveyance device 140 is used in a broad sense to identify an object in connection with, or used by, the customer 150 to operate or interact with the dispenser 130 and the system 110. Exemplary and non-limiting embodiments of the conveyance device 140 as described herein may include a receipt with a bar code, a cup or other receptacle with an identifier such as a bar code or an RFID tag, a wrapper or box of a food item or product which enables a dispense of an associated custom sauce or flavoring, or a mobile computing device, for example a smart phone which is operable to communicate with the dispenser 130 in the manners as disclosed herein. In an exemplary embodiment, a printer 160 which may make an adhesive label or print directly onto a cup or to a receipt or token is used to create each custom conveyance device 140. The printer 160 is exemplarily operated by the POS system 120.

Many embodiments as described herein may be implemented through the use of a bar code, for example, but not limited to, a QR two dimensional bar code. Such bar codes may exemplarily be printed on a receipt, on a cup, or generated or stored on a mobile computing device. The bar code may embed certain instructions or limitations including a recipe for dispense, a volume of dispense, a number of portions for dispense, or to lock or activate particular functions of the dispenser for that customer. In an exemplary embodiment, the receptacle may be filled with a base order and the dispenser provides the requested custom substances to the base order. Non-limiting examples of this would include a condiment, for example ketchup, a beverage, for example coffee, or a food, for example a hamburger, fries, chips, or a soup. In other embodiments, this order may be reversed, and the custom dispense (e.g. condiment, sauce, additive, or flavoring) is dispensed into the receptacle prior to placing the food or beverage into the receptacle as well.

In exemplary embodiments, bar codes may be used to facilitate recipe saving, sharing, or reusing, but may also serve as evidence of payment or entitlement, with scanning of the bar code providing the customer with “credits” or “portions” for dispense operation by the dispenser 130. These may come from a payment at the POS and printed on a receipt, or may be provided on a coupon. A coupon or receipt may be physical or digital. In the case of digital coupon it may be presented on the screen of a mobile computing device. The user could pay for a custom substance at the ordering counter, and could be presented a receipt with a QR code that they could unlock a flavored dispense with. They could also order the specific substance at the counter, which could also be communicated through the bar code. This may be desirable for featured or promoted sauces that are displayed on the dining room menu.

In another exemplary embodiment, the customer purchases a receptacle (e.g. portion cup) for example from the POS 120, each receptacle includes a bar code or an RIFD tag that enables one dispense associated with that number/identification. These numbers/identifications could be reset at an associated time interval (e.g. day or week) to refresh the associated numbers/identification for subsequent reuse. In the case of an RFID enabled receptacle, the dispenser 130 may be configured with an RFID reader and thus acknowledge the proximity of the receptacle and activate the associated dispense.

In another exemplary embodiment the QR code may be printed in the bottom of a cup or other receptacle. Upon scanning the barcode, the dispenser will be activated for a single dispense. The dispense of the custom substance into the cup obscures the barcode, preventing its use for further dispenses.

In a still further exemplary embodiment, the customer uses a mobile computing device, for example a smart phone to purchase dispenses of custom substances and activate the dispenser 130 to carry out the requested dispenses. In exemplary embodiments, the customer may pay separately with a phone or smart device via an app with saved payment information. This could for example use a third party payment engine like Venmo, Pay Pal, or others which may further a social media connection.

FIG. 3 is a system diagram that depicts an exemplary embodiment of a dispensing system, particularly focusing on an example of the communication and control functions of the dispensing system as disclosed in the present application. The dispensing system includes a controller 44. The controller 44 is exemplarily a microcontroller or microprocessor as would be recognized by a person of ordinary skill in the art and is communicatively connected, either by wired connections or wireless connections to sources of inputs/dispense information, for example the POS information system 120; the auxiliary input 18, exemplarily configured to read bar codes, or more specifically, QR two dimensional bar codes; or a user interface 22 presented on a graphical display 12.

The controller 44 is further communicatively connected to one or more non-transient computer readable media (CRM) 48, and able to read and/or write information to/from the CRM 48. While the CRM 48 is depicted in FIG. 3 as CRM 48A and CRM 48B, it will be recognized that the CRM 48 may encompass or be implemented with one or more CRM to carry out the function as described. In an exemplary embodiment, CRM 48 includes computer memory upon which computer code embodying software or firmware. Upon access and execution of the code by the controller 44, the controller 44 operates to send control signals, commands, and/or prompts to the components of the dispenser in order to carry out the functions of the dispenser as disclosed herein. CRM 48B exemplarily includes computer memory storing dispensing data which may exemplarily include information identifying the content of one or more specific reservoir locations or bags, the concentration and portion sizes thereof. In still further embodiments, QR code definitions and/or beverage or condiment recipes are stored in the CRM 48B.

As noted above, the controller 44 accesses and executes the computer readable code to prompt and/or receive one or more inputs of a custom dispense. The controller 44 then further executes computer readable code to output control signals to either to pumps 46 or other dispensing control devices (e.g. valves) to control the dispense of the requested customer order.

In an exemplary embodiment, execution of the computer readable code enables the controller 44 to read and interpret a bar code presented by the conveyance device 140, for example a cup or a smart phone screen. The bar code may exemplarily identify bay or receptacle locations within the dispenser and an associated amount of the substance at that location. The dispenser may have eight bays configured to each receive a receptacle or cartridge of a substance to be dispensed. The bar code may specify the bay from which a dispense should be made and an amount to dispense from that bay. This may provide an individual system, location, or facility flexibility to provide the actual available flavors or additive substances with limited programming or change to the system. Flavors can be added or removed from the system by inserting a different receptacle or cartridge of substance into the dispenser and making a similar update within the POS system. In an exemplary embodiment, “Bay 3” may contain a seasonal or limited-run or promotional flavor. The POS system simply encodes the barcodes specifying Bay 3 when the customer orders this flavor and the requested dispense is provided from the cartridge of seasonal or limited-run, or promotional flavor loaded into Bay 3. Such a system similarly enables the rotation or change or other flavors or substances with only associated updating at the POS system, if at all and without the need to update any software or controls at the dispenser itself.

In a still further exemplary embodiment, reading of the bar cade may identify a particular flavor, combination of flavors, base condiment/sauce, additive, and/or flavor intensity to the controller. In a further embodiment as described herein, a size and/or an order type (e.g. coffee, hot tea, or cold tea) may also be specified. The controller 44 may use this information with reference to the information stored in the computer readable medium 48B to determine which pumps 46 must be operated for which durations or speeds in order to produce the requested dispense, and then the controller 44 operates to send control signals to one or more pumps to carry out the dispense.

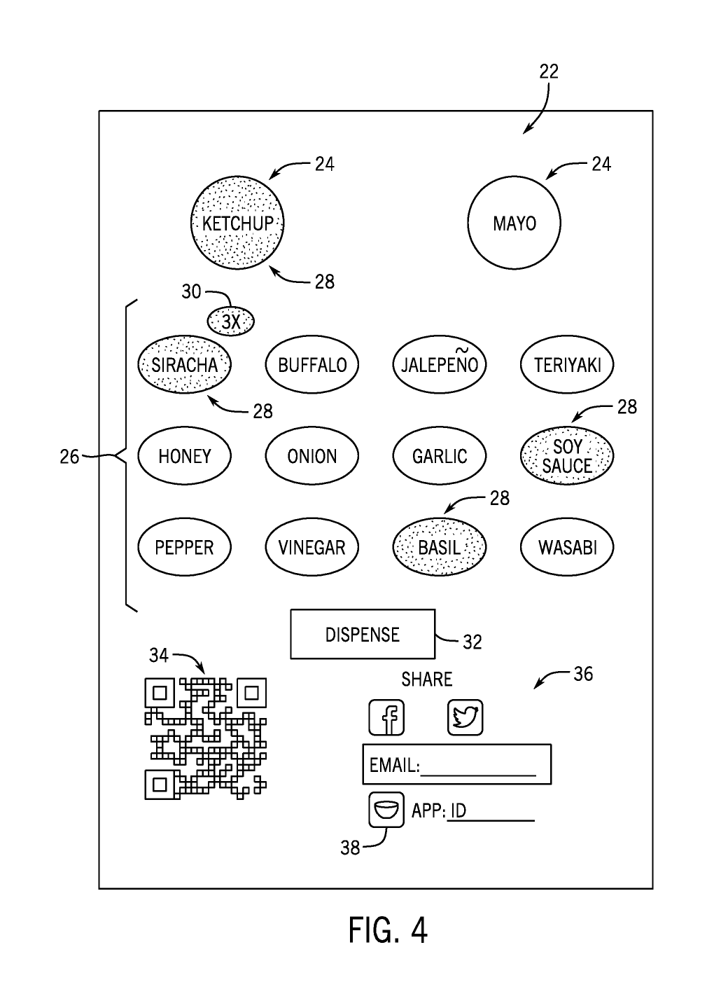

FIG. 4 depicts an exemplary embodiment of a graphical user interface (GUI) 22 as may be visually presented on the user interface 12 of the custom dispenser 10. The GUI 22 is exemplarily configured as a GUI for a custom condiment dispenser. The GUI 22 exemplarily includes a plurality of buttons as described herein which may be selected by a user, for example by physically touching the buttons in the case of a touch sensitive user interface. The GUI 22 includes base condiment buttons 24 for the selection of a base condiment and a plurality of flavoring buttons 26 for the selection of one or more additional flavorings. The user selects a base condiment button 24 to select a base condiment and then at least one, if not more flavoring buttons 26 to add additional flavoring to the selected base condiment. In an exemplary embodiment, once the user selects one of the base condiment buttons 24, that button becomes a highlighted button 28 to indicate that the user has selected that base condiment. Similarly, as the user selects flavoring buttons 26 those buttons also become highlighted buttons 28 to provide a similar indication. It will be recognized that the highlighted buttons 28 may exemplarily be a visual indication such as darkening or lightening, or brightening the button selection or providing another very perceptible change to the button to indicate selection as will be recognized by a person of ordinary skill in the art. In additional embodiments, if a user selects a flavoring button 26 more than once, an indicator 30 will appear to denote the number of “portions” of the selected flavor to be added in making the custom condiment.

In exemplary embodiments, the intensity of the flavoring in the custom condiment may be achieved in various ways depending upon the form of the flavoring. For example, if the flavoring is a concentrated liquid, the intensity may be controlled by increasing the volume of the concentrated flavoring. If the flavoring is a flavored carrier sauce, reservoirs may be provided with carrier sauces mixed with different concentrations of the concentrated flavoring. In a non-limiting embodiment, three levels of intensity carrier sauces may be provided a low intensity with e.g. 6% concentrated flavoring, a medium intensity with e.g. 12% concentrated flavoring, and a high intensity with e.g. 18% concentrated flavoring. In a still further exemplary embodiment, a reservoir of the carrier sauce may be mixed with varying amounts of the concentrated flavorings to produce a requested intensity of the flavoring. Such an embodiment may be beneficial by reducing the required inventory of flavorings (by eliminating separate intensity reservoirs) while still providing advantages in mixing of the custom condiment provided by the use of the carrier sauce. After the user has selected the custom condiment, the user selects the dispense button 32. Upon receiving an input of selection of the dispense button 32, the custom condiment dispenser operates in the manner described above to produce the selected custom condiment.

As will be described in further detail herein, the dispensing system also operates to produce a recipe identification (“recipe ID”) 34. The recipe ID 34 is presented on the GUI in the manners as described herein. The recipe ID 34 is exemplarily depicted in FIG. 3 as a QR code. In embodiments, the recipe ID 34 may be any of a variety of identifiers, including, but not limited to barcodes or other two dimensional barcodes, as well as numerical or alpha-numerical identifiers capable of functioning in the manners as described herein. The recipe ID 34 embodies the custom condiment as selected by the user, and may the base condiment, and one or more flavorings or any other information need by the dispenser to produce the custom dispense. The recipe ID may be used in embodiments as described in further detail herein.

The GUI 22 further includes a share section 36 which provides the user with the option to share the custom condiment, and particularly the recipe ID 34, through social media or other communication channels. As non-limiting examples, the user may share or send the recipe ID through Facebook, Twitter, to an e-mail address, or to a coordinated app on a mobile computing device, exemplarily a smart phone. In one such embodiment, the user may enter an app ID number or user name and selection of the app button 38 to forward the recipe ID to the user entered account for access using the mobile computing device. It will be recognized that implementation of embodiments like these may require a communicative connection, for example a wired or wireless connection to access a network or the internet.

User interaction with the GUI 22, exemplarily depicted in FIG. 3 inputs commands to the controller 44 as exemplarily depicted in FIG. 3. In an embodiment, upon user selection of the dispense button 32, the custom condiment dispenser 10 operates to dispense the selected custom substance in the manners as presently disclosed. In embodiments, the timing and control of the dispense can be carried out in a number of ways while remaining within the present disclosure. Upon a selection of the dispense button 32, the dispenser may dispense a predetermined volume or a user selected volume. A single interaction with the dispense button may initiate dispense of the entire defined volume. In another embodiment, the dispenser may dispense as long as the user continues to touch or otherwise engage the dispense button 32. This embodiment may be limited by a maximum dispense amount. In an example, the dispenser will dispense up to a predetermined full dispense volume which may exemplarily be a portion e.g 1 oz, 1.5 oz, 2 oz, or 6 oz, although these are not intended to be limiting on the volume of such a maximum dispense amount. Embodiments such as this allow the user to control the precise volume dispensed by stopping dispense at the user's discretion, while also limiting excessive dispense and waste of condiment.

In an embodiment of the custom condiment dispenser 10 that dispenses custom condiments of multiple base condiments, the custom condiment dispenser 10 may use different nozzles to dispense each of the base condiments with flavorings. In such an embodiment, the GUI may operate to move the dispense button 32 or provide the dispense button 32 that is oriented relative to the nozzle from which the custom condiment will be dispensed (not depicted). Exemplarily, the dispense button 32 is aligned above the nozzle from which the custom condiment will be dispensed. In one embodiment, a single dispense button is moved in the GUI 22 to a position associated with the nozzle from which the custom condiment will be dispensed. In another embodiment, multiple dispense buttons are provided which are aligned with respective nozzles with which the dispense button is associated. In an embodiment, the dispense button associated with the nozzle from which the custom condiment will be dispensed is highlighted, illuminated, bolded or otherwise made visually compelling while the other dispense buttons may be shaded, lightened, or otherwise hidden to direct the user to the nozzle from which the custom condiment will be dispensed.

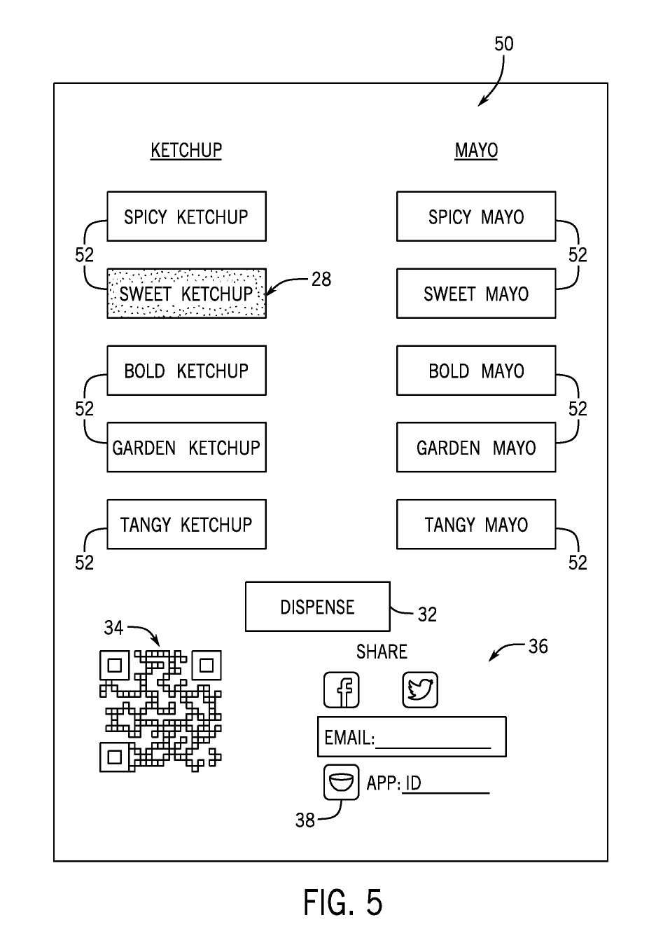

FIG. 5 depicts an additional exemplary embodiment of a graphical user interface (GUI) 50. The graphical user interface 50 depicted in FIG. 4 includes similar features as highlighted above with respect to the graphical user interface 22 of FIG. 4. These features are identified with like reference numerals for the sake of conciseness. The GUI 50 differs from the GUI 22 in that the GUI 50 is configured to present a plurality of predefined custom condiments from which the user may choose by selecting a custom condiment button 52. It will be recognized that each of the custom condiments represented by each of the custom condiment buttons itself has an underlying recipe comprising at least one base condiment and at least one portion of flavoring. In embodiments where only flavoring is dispensed, the underlying recipe may include only one or more portions of flavoring. These custom condiments may be proprietary to a particular restaurant or group of restaurants and may be dispensed from the custom dispenser using premixed or on demand mixed custom condiment. In one embodiment a user selection of one of the custom condiment buttons 52 results in a highlighted button 28 and the selected custom condiment is dispensed on a further user selection of the dispense button 32. In a still further embodiment, the dispense button 32 may be eliminated and the custom condiment is dispensed upon selection of a particular custom condiment button 52. In a still further embodiments, the user may select two or more custom condiments before selecting the dispense button 32 at which point the custom condiment dispenser may dispense a further custom condiment with a mixture of the previously selected custom condiments.

As described above, the GUI 50 further produces a recipe ID 34 which may be used as described in further detail herein and is representative of the custom condiment selected by the user and dispensed by the custom condiment dispenser. A share section 36 as described above is similarly included in the GUI 50 to facilitate user transmission and/or communication of the recipe ID 34. In still further embodiments, a user may acquire the recipe ID 34 directly from the GUI, for example by taking a picture of the recipe ID 34 with a smart phone or digital camera or receiving the recipe ID 34 from within an app operating on a mobile computing device, the app coordinated for use with the custom condiment dispenser and/or a restaurant using the custom condiment dispenser. The app may have a scanning function utilizing the device's camera to capture the code, or it may communicate wirelessly with the unit (i.e. NFC or WiFi).

In an embodiment, each of the custom orders presented on the GUI 50 are exemplarily for recipes offered or promoted by the restaurant or vendor. These custom orders may also be examples of those custom orders encoded in a bar code affixed to a cup from the POS in embodiments wherein the customer order is placed at the POS and encoded on the cup. In an embodiment, the recipe ID 34 is the same as the bar code encoded on the cup by the POS. in a further embodiment, scanning a recipe ID with the auxiliary input will result in the order being presented on the GUI with the corresponding buttons highlighted.

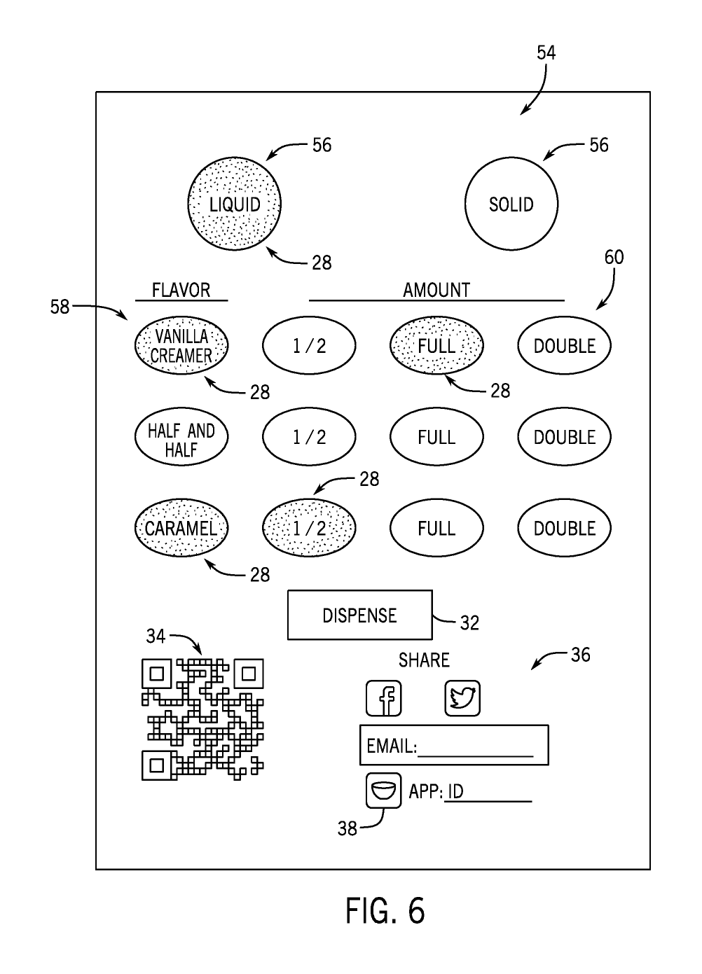

FIG. 6 depicts an exemplary embodiment of a graphical user interface (GUI) 54 as may be visually presented on the graphical display 12 of the dispenser 10. The GUI 54 includes similar features as presented above with respect to FIGS. 4 and 5, although arranged to dispense one or more flavors or additives, for example into a hot coffee, hot tea, iced coffee, or iced tea beverages. The GUI 54 includes a plurality of buttons which may be selectable by a user, for example by physically touching the buttons in the case of a touch sensitive user interface. The GUI 54 includes substance category buttons 56 for the selection between liquid or solid additives. It will be understood that in another embodiment all of the available selections will be presented to the user in a single screen. The GUI 54 further includes a plurality of flavor buttons 58 and amount buttons 60 which provide the customer with options for a selection of flavors and the amount of that flavor to use. The user selects at least one, if not more, flavoring buttons 58 followed by a selection of an amount button 60 to make their custom selection. In an exemplary embodiment, once the user selects one or more buttons, that button becomes a highlighted button 28 to indicate that the selection has been made. It will be recognized that the highlighted buttons 28 may exemplarily be a visual indication such as darkening or lightening, or brightening the button selection or providing another very perceptible change to the button to indicate selection as will be recognized by a person of ordinary skill in the art.

As in the embodiment described above, a receipt ID 34, is exemplarily depicted in FIG. 6 as a QR code, is produced that embodies the custom substance selected by the user. In exemplary embodiments, the recipe ID 34 may exemplarily be any of a variety of identifiers, including, but not limited to barcodes or other two dimensional barcodes, as well as numerical or alpha-numerical identifiers capable of functioning in the manners as described herein. The recipe ID 34 may encode one or more liquid or granular substances dispensed into a single beverage, or for use with a beverage. In embodiments, the recipe ID 34 may or may not also include a portion amount or a beverage size.

In one exemplary embodiment, the custom order recipe may include a specific sequence in which a plurality of substances are dispensed. In one non-limiting example, granular substances may be dispensed prior to liquid substances. In another embodiment, substances may be dispensed into a beverage in a cup in a particular order to create an aesthetic effect. As an example, creamer or flavored creamer may be dispensed first, followed by a chocolate or caramel sauce. In another example, flavored creamer may be dispensed first, followed by whip cream, followed by a decorative granular substance and/or a chocolate or caramel sauce.

While the current embodiment depicted present the examples above the amount buttons 60 in terms of relative to a particular portion, it will be recognized that rather than indicating a “half” portion in other embodiments, the portion dispense size may be smaller and/or may be determined relative to a beverage size and the amount characterized in terms of a number of portions to use. In certain embodiments, different types of beverages may require different portions to achieve a desired flavor profile. In this case the GUI may have a selection for both beverage type and size to automatically adjust portions. After the user is done making the selection, the user selects the dispense button 32. Upon receiving an input of selection of the dispense button 32, the dispenser operates in the manner described above to make the requested dispense.

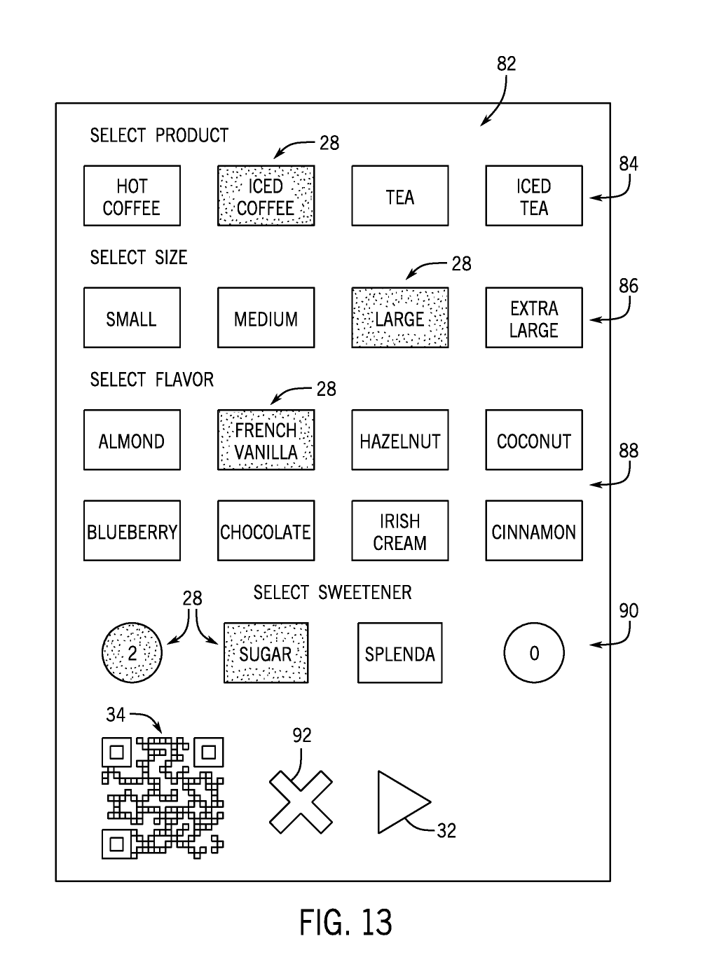

FIG. 13 is an exemplary embodiment of a user interface for a custom flavoring dispenser. Similar to FIG. 6, the user interface 82 presented in FIG. 13 is configured for a user to input a selection of a custom flavor to be provided in a beverage. It will be recognized that in certain embodiments, different types of beverages may require different portions to achieve a desired flavor profile. In such an embodiment, as represented in the GUI 82 the user is presented with a selection of both the beverage type 84 and the beverage size 86. Upon receipt of the entries in the custom order, the system is able to interpret this requested product and size in accordance with the strength or concentration of the selected flavors 88 in order to automatically adjust the portion dispensed. In such a manner, the dispense provides the correct amounts of the flavorings into the receptacle for later receipt of the beverage. As further depicted in FIG. 13, the user is also able to select a sweetener 90 which may be provided as sugar or a sugar substitute (e.g. Splenda) and an amount of sweetener may be selected by entering the sweetener button one or more times. The user also able to cancel the order by selection of a cancel button 92 or dispense the custom order by selection of a dispense button 32. As with other embodiments previously described, the custom order is represented in a recipe ID 34 presented on the GUI 82. As the user makes selection, the selected buttons become highlighted buttons 82 so that the user has a visual confirmation of the input order. As noted above, in embodiments wherein the recipe ID is provided directly to the dispenser, entry of recipe ID may result in the GUI 82 prepopulating the GUI 82 with the highlighted buttons 28 associated with the input recipe ID.

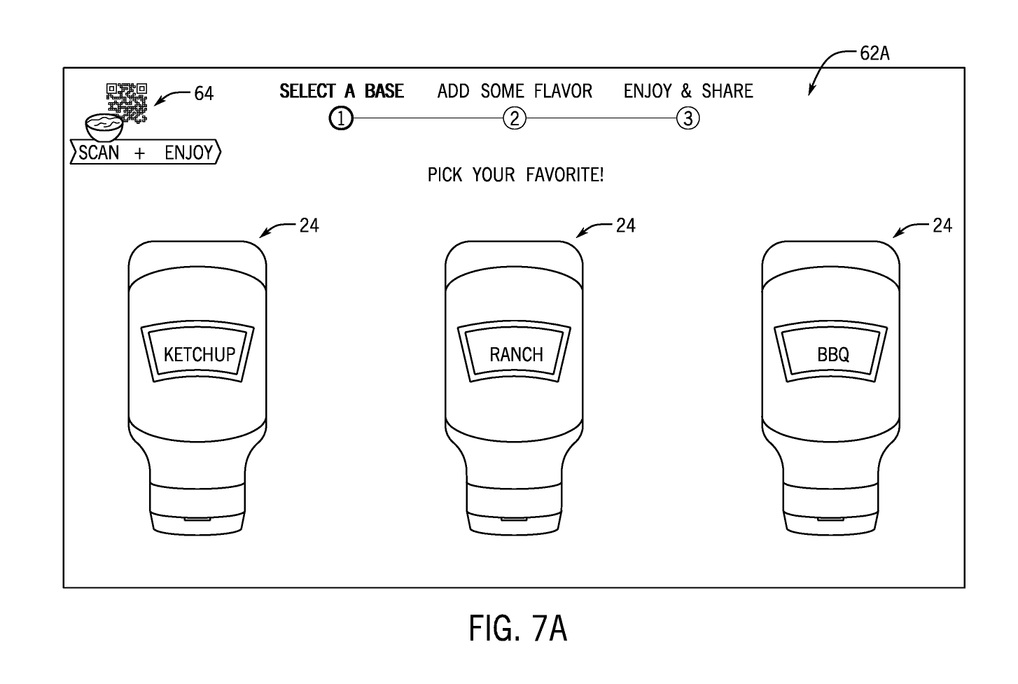

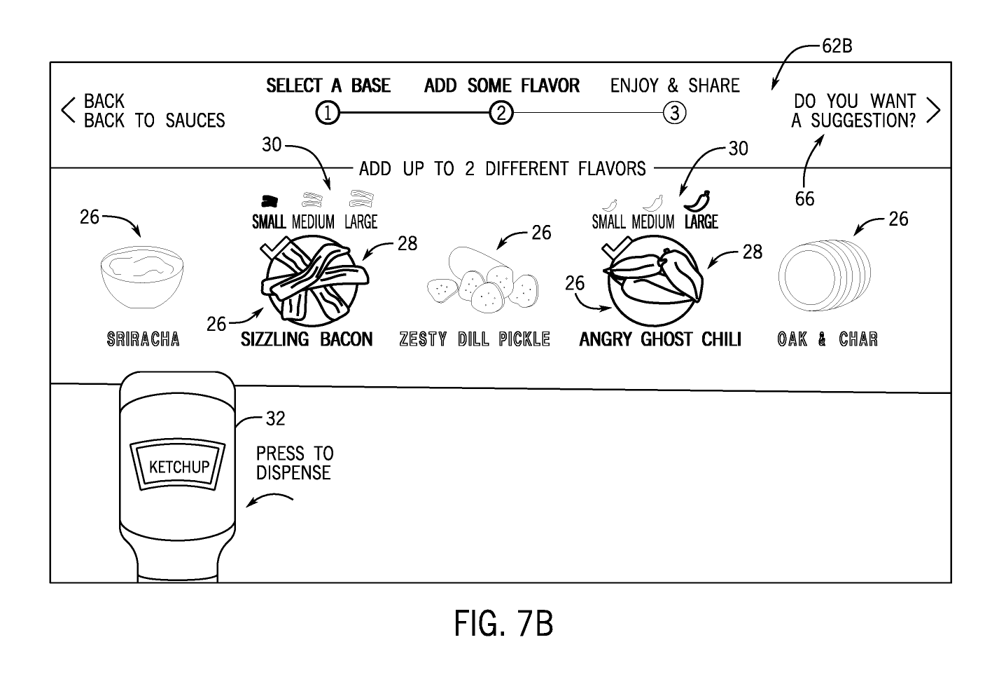

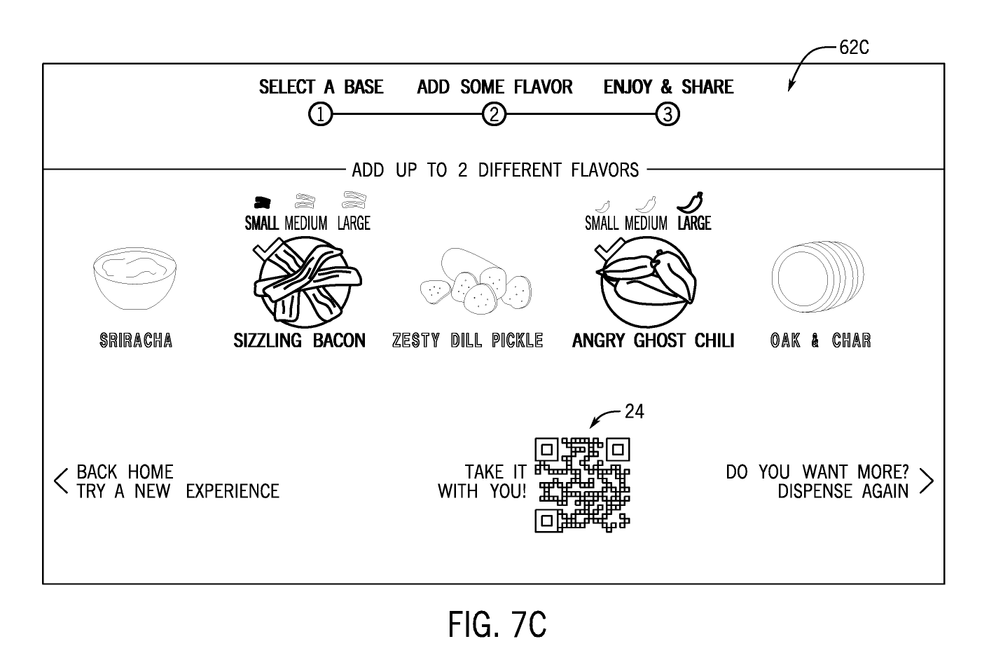

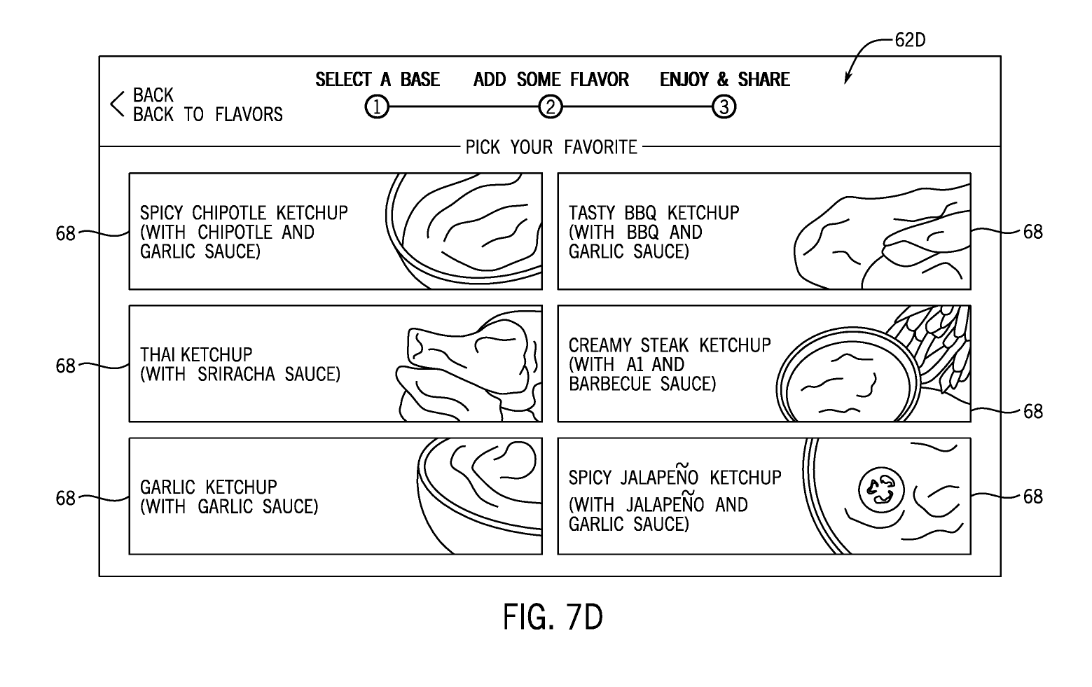

FIGS. 7A-7D depict an additional exemplary embodiments of a graphical user interface (GUI) 62. The graphical user interface 62 depicted in FIGS. 7A-7D includes similar features as highlighted above with respect to the GUI's discussed previously, particularly GUI 22 of FIG. 4. These features are identified with like reference numerals for the sake of conciseness. It will be recognized that while the examples given with respect to FIGS. 7-10 are provided in connection with a custom condiment dispenser, that other custom substances may be similarly dispensed. The GUI 62 differs from the GUI 22 in that the GUI 62 is configured to operate across a plurality of screens based upon user selections rather than incorporate all of the user controls into a single screen.

In the first screen 62A, the customer is presented with the options of base condiments 24. In this exemplary embodiment, the base condiments are ketchup, ranch, and barbeque sauce. Selection of the auxiliary input button 64 by the customer will enable the auxiliary input device 18, as described above, to receive an input, for example of a recipe ID in the form of a QR code to select a custom condiment for dispense.

Upon receiving a selection of a base condiment 24 by the customer, the GUI navigates to a second screen 62B depicted in FIG. 7B. In the exemplary embodiment, the customer has selected ketchup and the customer is presented with a plurality of flavoring buttons 26 representing different flavors which may be added to the selected base condiment of ketchup. In the example presented, the flavorings are sriracha, sizzling bacon, zesty dill pickle, angry ghost chili, and oak & char. When the customer selects one or more of the flavoring buttons 26, the selected button becomes a highlighted button 28, indicating back to the customer, the customer's current selections. In this example, the customer has selected sizzling bacon and angry ghost chili. Once a flavoring is selected, then an intensity indicator 30 is presented in connection with the highlighted button 28. The customer may select from e.g. small, medium, or large amounts of the flavoring, wherein the customer has exemplarily selected a small amount of sizzling bacon and a large amount of angry ghost chili. Upon the selection of the flavorings and intensity for the custom ketchup, the customer selects the dispense button 32 to dispense the custom ketchup. In an exemplary embodiment, a separate nozzles may be used to dispense each of custom ketchup, custom ranch, and custom barbeque sauce. As depicted in the GUI 62 the positioning of the base condiment buttons 24 and the dispense button 32 may be related to the position of the associated nozzle to help customers accurately receive the dispensed condiment.

After the custom condiment is dispensed, the GUI exemplarily navigates to third screen 62C, presented in FIG. 7C, in which the recipe for the dispensed custom sauce is presented and the recipe ID 34, which is exemplarily in the form of a QR code presented to the customer. As described above, the customer may take a picture of the recipe ID 34, send it to themselves or others, or share it through social media platforms.

FIG. 7D presents an exemplary embodiment of another screen 62D of the GUI. Referring back to FIG. 7B, a suggestion button 66 prompts the customer to be presented with preconfigured custom condiment recipes. Upon selection of the suggestion button 66 by the customer, the GUI navigates to screen 62D to present a plurality of predefined custom condiments from which the user may choose by selecting a custom condiment button 68. In the example depicted, various predefined custom ketchup flavors are presented. It will be recognized that each of the custom condiments represented by each of the custom condiment buttons 68 themselves have an underlying recipe comprising at least one base condiment and at least one portion of flavoring. In exemplary embodiments the custom condiments may comprise the base condiment and flavorings available through the system. These custom condiments may be proprietary to a particular restaurant or group of restaurants. In still further embodiments, one or more of the presented selections may be dispensed from the custom condiment dispenser using premixed or on demand mixed custom condiment. In one embodiment a customer selection of one of the custom condiment buttons 68 navigates the customer to a screen similar to screen 62B to dispense the selected custom condiment is dispensed on a further user selection of the dispense button 32. In a still further embodiment, the dispense button 32 may be eliminated and the custom condiment is dispensed upon selection of a particular custom condiment button 68.

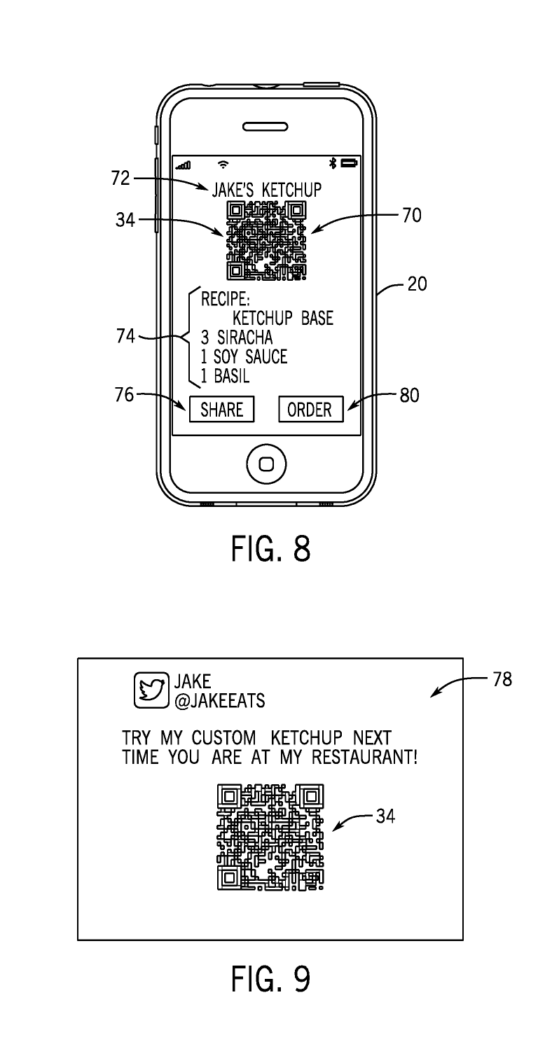

FIG. 8 depicts an exemplary embodiment of a mobile computing device 20, which is exemplarily a smart phone and presents an exemplary embodiment of an app GUI 70 presented on the mobile computing device 20. The app GUI 70 exemplarily presents the recipe ID 34 in a prominent manner. In an exemplary embodiment, and as described in further detail herein, a user may use this representation of the recipe ID 34 to be read by the auxiliary input device 18 of the custom condiment dispenser 10 (FIG. 1) on a subsequent visit to enter the custom condiment rather than provide individual selection with the user interface of the custom condiment dispenser. The app GUI 70 may be used to create a name 72 for the custom condiment. The app GUI 70 further may include a detailed recipe 72 corresponding to the custom condiment represented in the recipe ID 34. As previously discussed, the user may share the recipe ID or the custom condiment either through social media or through direct communication forms including, but not limited to e-mail and text messaging, for example by selecting the share button 76.

FIG. 9 depicts an exemplary embodiment of a screen shot of a social media post 78 which includes the recipe ID 34. By sharing the recipe ID 34 on social media, other third party followers of the user can acquire the recipe ID 34 and use that recipe ID 34 to order the same custom condiment produced by the custom condiment dispenser as the original user.

Referring back to FIG. 8, an order button 80 may exemplarily provide a link to an online ordering functionality within the app or another app associated with the restaurant, or connect to ordering functionality through the Internet for mobile ordering. As described in further detail herein, in embodiments, the user may incorporate the recipe ID 34 into an online order and the recipe ID 34 may be used by a restaurant or food service worker to prepare the order and include the custom condiment as defined by the recipe ID 34.

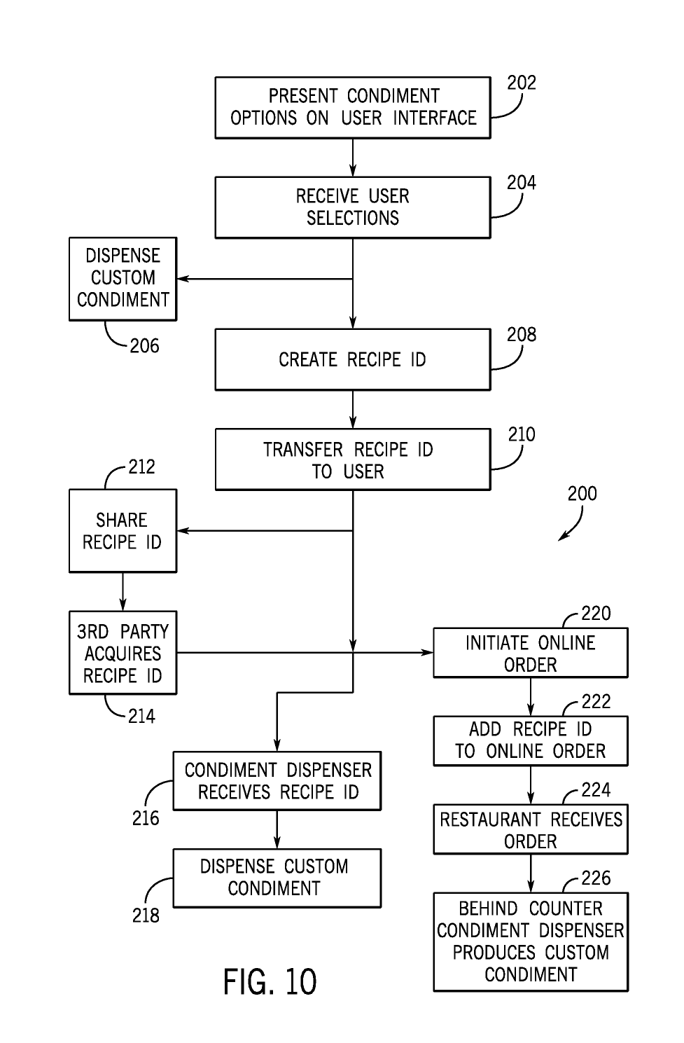

FIG. 10 is a flow chart that depicts an exemplary embodiment of a method 200 of custom condiment dispensing. It will be understood that exemplary embodiments of the method 200 may be carried out through the use of one or more of the structures and/or user interfaces as described above, although persons of ordinary skill in the art will also recognize other manners of carrying out the method 200 as described herein in accordance with the disclosure.

At 202 condiment options are presented on a user interface. In exemplary embodiments the condiment options may be selections of base condiments and flavorings from which the user may make selections or the condiment option may be a plurality of predefined custom condiments from which the user is able to select. At 204 the custom condiment dispenser receives user selections from the presented condiment options. The custom condiment dispenser operates at 206 to dispense the requested custom condiment. At 208 a recipe ID is created and presented to the user. The recipe ID may exemplarily be a one-dimensional or a two-dimensional barcode or another form of a numeric code that is representative of the condiment selected by the user.

The recipe ID is transferred to the user at 210. As previously described, the recipe ID may be transferred to the user in a variety of ways including, but not limited to reading or capturing the recipe ID presented on the GUI of the custom condiment dispenser, exemplarily with a mobile computing device such as a smart phone. In other embodiments, the recipe ID is transferred to the user exemplarily through e-mail or by a wireless communication to an associated app or to a mobile computing device. At 212 the user has the option to share the recipe ID with others, exemplarily through social media, for example Facebook or Twitter, as well as through e-mail or text messaging platforms. The sharing of the recipe ID at 212 by the user can be carried out either though the user interface of the custom condiment dispenser itself or through an app associated with the user in the custom condiment dispenser operating, for example on a mobile computing device.

At 214 one or more third parties acquire the recipe ID shared by the original user. After acquiring the recipe ID, the third party may use the recipe ID in any of the same manners as the original user for whom the recipe ID was originally created as will be described in further detail herein.

At 216 the recipe ID may be used to facilitate operation of the custom condiment dispenser for example by providing the recipe ID to the auxiliary input device 18 of the custom condiment dispenser. In an exemplary embodiment, the recipe ID may be a QR code and the auxiliary input device 18 is a QR code reader. However, in other embodiments, other methods of data transfer may be used. For example, the auxiliary input device may be a wireless communication device operating exemplarily on a WI-FI or BLUETOOTH communication protocol and through which a mobile computing device of the user may transmit the recipe ID to the custom condiment dispenser. Further embodiments may exemplarily use near-field magnetic inductance or infra-red communication in order to transfer the recipe ID. Once the custom condiment dispenser receives the recipe ID, the custom condiment dispenser can be operated to dispense the custom condiment at 218.

In another exemplary embodiment, the customer places an order for a custom flavored beverage or a custom condiment at a POS of a restaurant or other foodservice provider. If the customer has a previously saved recipe ID, the customer may use this recipe ID to facilitate ordering at the POS. The POS creates the associated recipe ID, for example at 208 and the recipe ID is transferred to the customer at 210 by printing a label or direct printing a bar code or other indicia onto a cup. The cup may then be filled with the base beverage for the order and provided to the customer. In another embodiment, the dispenser may also provide the base beverage into the cup. The customer takes the cup to the dispenser and uses the bar code or other indicia to input the custom order into the dispenser, for example at 216, from which the dispenser operates to dispense the custom order at 218.

In a further exemplary embodiment, a recipe ID is used in the context of an online order, for example to place an order for delivery or for in restaurant pick-up. At 220 the user initiates an online order (via device app or web-based app) for food from the selected restaurant that offers the custom condiment. The course of placing the online order at 222 the user adds the recipe ID to the online order and requests custom condiment according to the recipe ID. The user may also configure the recipe via the ordering interface without a preexisting ID. The restaurant receives the order at 224 the received order includes not only food and drink selection, but also one or more recipe ID's to customize these orders. The food service worker at the restaurant begins preparing the items in the received order. At 226 when the custom condiment is to be prepared by the food service worker, a behind the counter dispenser is operated by the food service worker to produce the custom orders. In an exemplary embodiment, a computer, mobile or otherwise, receives the online orders, including the at least one recipe ID. This computer may be a part of or integrated with the POS system of the restaurant. The computer is communicatively connected to the auxiliary input device of the custom condiment dispenser and the recipe ID for the online order is provided to the dispenser so that the dispenser can be operated to produce the custom order.

In one embodiment, the POS system may integrate with the dispenser to present the custom orders on a graphical display. As the foodservice worker prepares the exemplary custom beverage, the foodservice worker selects the custom order to complete the beverage and the custom order is dispensed into the base beverage in the cup. In certain embodiments, dispensing may be automatically triggered upon receipt of order. In such embodiments interaction with the POS system may automatedly locate a receptacle relative to a nozzle of the dispenser and automatedly dispense the custom order into the receptacle. In another embodiment, the POS system may operate to print the bar codes or other indicia on labels or directly onto cups. When the foodservice worker is preparing that custom order, the foodservice worker scans the bar code or indicia to enter the custom order into the dispenser which operates to complete the custom order.

In a related embodiment, the custom orders may be fulfilled by a foodservice worker using the dispenser in a “behind the counter” arrangement in the manner described above when the customer is in the restaurant or store as well. Integration of the POS system with a behind the counter embodiment of the dispenser can facilitate foodservice worker preparation of custom orders, including custom beverages by either selection of the custom order from a user interface communicatively connected to the POS system to report and list all of the custom orders. Alternatively, as described above, the foodservice worker may scan a barcode or other indicia printed or affixed to the cup to input the custom order to be dispensed into the cup to complete the customer's order. It will be recognized that in still further exemplary embodiments, cups may be printed or labelled with advertising for example with suggested recipes, promotions, or coupons for future sauce purchases. In still further exemplary embodiments, the cups may be printed on directly on demand with suggested food pairings or with a label for the purchase. The cup may further include instructions for acquisition and use of a coordinated app on a mobile computing device. A label or cup printer could be built in to cup holder system associated with the POS and/or the dispenser. A label printer could be in close proximity to lid or cup storage area, and may even have applicator to aid in adhering label to container. The cups could be designed to easily attach to a food container like a cardboard fry sleeve. Food containers could have a reservoir for sauce built in, and could be designed for insertion into vehicle cup holders. A dispenser can stage cups pre-dispense so the crew member does not have to place the cups below a nozzle prior to dispense.

In an embodiment, the cup may be printed on or receive a label with a QR code for a specified recipe. As previously noted, this QR code or other indicia can encode a variety of information to represent the custom order. In one embodiment, the custom order may be encoded by identifying specific substances to dispense and the volumes of these substances to dispense. In another embodiment, the custom order may be encoded by an identification of one or more reservoir or cartridge locations (e.g. “bays”) and a number of predetermined volume units. The substance may be changed by changing out the reservoir or cartridge located in the specified bay and noted in the POS system. In a still further exemplary embodiment, the custom order may be encoded to further specify a size (e.g. volume) and a substance of an associated food or beverage with which the dispensed substance will be used. One example may be a medium hot coffee while another example may be a “6 inch” sandwich or a large order of french fries. This information may be either used to also dispense or subsequently dispense a base beverage or to adjust or modify the portions of the requested substances in the custom order, for example in relation to the volume or use the custom substance. This QR code may be used by the restaurant worker to specify the order to be dispensed into the cup, and the customer may later use the QR code to save the recipe for later reference or use in later orders.

While not limiting on the scope of the present disclosure, embodiments of the custom condiment dispenser are contemplated for dispense of small volumes of custom condiments. Three exemplary use cases exhibit the types of small volumes of custom condiments contemplated as opposed to other food processing solutions which use a bulk processing method for flavored sauces. In one embodiment, the custom condiment dispenser dispensed the custom condiment directly onto a piece of food, for example a hamburger, a hot dog, a sandwich or a bun used with any of the aforementioned foods located in the dispensing area below the nozzle. In another embodiment, the custom condiment is dispensed into a portion cup to be provided to a customer along with a food order. In both of these two examples, the contemplated dispense volume may be between 0.5 oz to 2.0 oz. In still further embodiments wherein only flavoring is dispensed, the flavoring may be concentrated and a dispense may be as little as 0.015, while other flavoring substances may be less concentrated and dispensed between 0.5 oz and 2.0 oz.

In a still further embodiment, the custom condiment dispenser may be used in a “behind-the-counter” use to make specialty sauces which are dispensed into a dispensing container (e.g. a ketchup bottle) either for use by a food preparation worker to dispense onto prepared food or for placing at a table or station for use by a customer. In a non-limiting embodiment, such volumes of dispensing containers may exemplarily be 6 oz-12 oz. These disclosed ranges are merely exemplary of potential uses of the disclosed custom condiment dispenser, it will be recognized that alternative embodiments may be used to dispense between 2 oz and 6 oz, or other volumes above or below this range.

In exemplary and non-limiting embodiments, the custom condiment dispenser may be self-cleaning or partially self-cleaning. In an embodiment wherein the custom condiment dispenser is connected or connectable to a water supply and a water disposal line, for example as may be provided by appropriate connections to the plumbing of a restaurant or other food service, convenience, or vending establishment. In such an embodiment, the custom condiment dispenser may be operable (for example under the control of the processor after input of an option or cleaning command by a user) to draw water into the custom condiment dispenser, flush the flexible tubes of condiment and dispense of the dirty water. In a still further embodiment, the self-cleaning may be semi-automated, requiring fluid connections to be made by the user between the custom condiment dispenser and fresh water, solvent water as well as to connect the nozzles to a plumbing drain. Upon receipt of a command from a user, the custom condiment dispenser will draw solvent water into the system to flush and clean the flexible tubing, nozzles, flavoring and/or condiment inlets, pumps, and/or valves or any other component that comes in contact with the dispensed food and/or flavorings. After solvent water is distributed through the system, fresh water may be circulated through the system to remove any loosened food as well as to flush the system of the solvent water. The used solvent water and/or the used fresh water may be dispensed into a drain through the nozzles, cleaning the nozzles as well.

In an exemplary embodiment, upon receiving an input exemplarily through a QR code read by the auxiliary input device, the custom condiment dispenser may enter into a set up or maintenance mode, whereby a technician gains access to controls, settings, code scripts, or other variables relied upon by the custom condiment dispenser 10 to function properly. This may exemplarily be used to switch the settings to reflect a change in base condiment, a change in flavorings, or to adjust for a geometry of a new nozzle or other component.

In other exemplary embodiments, upon receiving an input, exemplarily a QR code read by the auxiliary input device 18, the custom condiment dispenser may carry out a function, for example to initiate a cleaning routine. The cleaning routine may be carried out automatically if cleaning solution and disposal capabilities are already provided to the custom condiment dispenser. In an alternative embodiment, as part of the cleaning routine initiated by the input to the auxiliary input device, the graphical display may be operated to provide a user with instructions for manual portions of a cleaning routine in a semi-automated process.

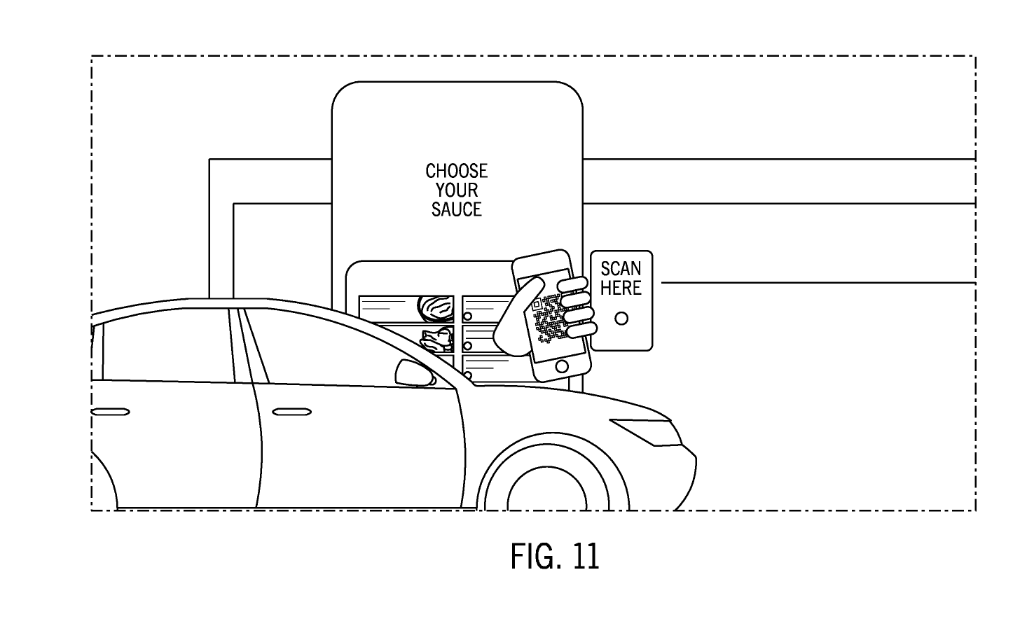

FIG. 11 exemplarily depicts a restaurant drive through ordering system, a custom food ordering kiosk may facilitate user interaction and ordering. It will also be understood that an ordering kiosk may be used in other settings, for example for in-store ordering. Exemplary embodiments of the kiosk may include a user interface, for example a touch-screen user interface. The ordering kiosk could have a module that the user can interact with directly as opposed to the POS interface operated by a marker or a mobile ordering app for food or sauce via smart device. The module could be a touch screen through which the user selects and submits a food order and any custom recipes a worker or a mobile ordering app for food or sauce. Embodiments of the kiosk may further include other mobile computing device enabled communications systems as described herein for familiar users. In a still further exemplary embodiment, customer could indicate specific recipe verbally at the ordering kiosk, and through speech recognition the recipe could be entered into the POS system and sent to the dispenser. In another embodiment, the customer could indicate an order for a custom sauce, but then specify recipe at drive-through windows when interacting face to face with a food service worker.

Still other exemplary embodiments use wireless communication to enable some or all of the custom food ordering to be performed using a mobile computing device of the customer, for example a smart phone. User uses the mobile computing device to communicate with the ordering kiosk or drive-through window to request recipe, via NFC, QR, WIFI, Bluetooth, etc.

In an exemplary embodiment, a communication system, which may exemplarily be a scanner module could protrude from the kiosk, or the communication system could be built in near the confirmation screen or speaker. This scanner may include a barcode scanner that reads a QR code generated by the mobile computing device. In other embodiments the communication system at the ordering kiosk or drive-through window may be a wireless communication system (e.g. NFC, WIFI, Bluetooth, etc.) that communicates with the mobile computing device directly. The mobile computing device, for example operating an app configured to facilitate such ordering produces a signal (e.g QR or wireless) that identifies a specific custom flavor and/or amount of custom flavor (e.g. 0.5 oz, 1 oz, 2 oz).

In exemplary embodiments, the ordering kiosk or menu at the point of sale, which could include a digital menu presented to and/or navigated by the customer could suggest food pairings and sauce combinations or promotions before or after the user selects a recipe.

In the interest of reducing drive-through process time, the recipes may be limited to pre-selected and featured options determined by the restaurant. These recipes may be communicated via a section of the menu or promotion board in the drive-through lane, or by a monitor included on the menu or on the ordering kiosk. This monitor may interact with the unit wirelessly or via ethernet, and thus may be updated through the unit interface. The restaurant (e.g. a worker at the restaurant or a worker communicatively connected to multiple restaurants, for example through the internet) may select a set of featured recipes for the day and submit them to be displayed at the ordering kiosk or at the drive through windows. These featured recipes could be displayed on a touch screen that the user selects directly.

In either of the embodiments above using an ordering kiosk with touch sensitive inputs or with a mobile computing device enabled ordering system, the system is communicatively connected with the restaurant POS system and in an exemplary embodiment communicates directly (or through the POS system) with the custom food dispenser.

In a still further exemplary embodiment, customers may interact with the restaurant worker taking their order more directly to order a custom food, for example a custom condiment. The restaurant worker may have a module or scanner to interact with the user's smart device that communicates with the POS system, or directly with the unit via wireless or ethernet communication. The restaurant worker may alternatively have a user interface in the form of a module, kiosk, or touch-sensitive display that the user can interact with directly instead of via smart device. The restaurant worker enables or provides the user interface to the customer and the customer selects or creates a recipe and submits it. The touch screen may only display featured recipes that have been predetermined by the restaurant to reduce time of transaction.

After the order is placed, the recipe requested by the customer may be input into the dispenser by the restaurant worker through ingredient selection directly into the dispenser. In another embodiment, the dispenser is connected directly to the POS system and the requested recipe may be staged and appear pre-selected after receiving the recipe from the POS system or other ordering modules. In the case that the recipe is staged, the restaurant worker may simply trigger a dispense via the interface of the dispenser. The dispense of the requested order could also be triggered by the placement of the portion container beneath the nozzle to speed up crew member interaction.

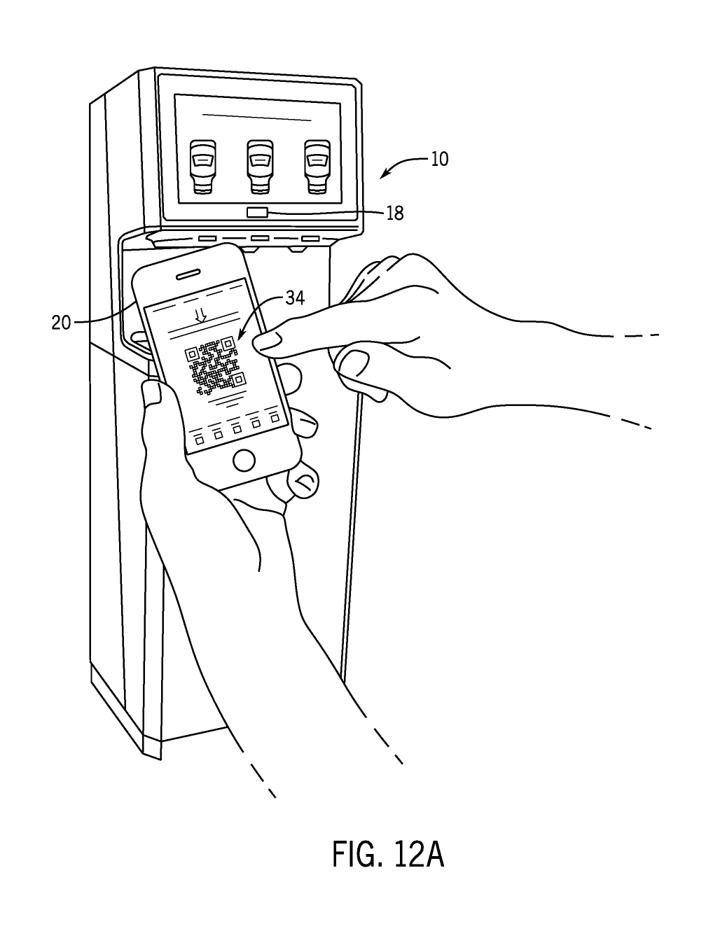

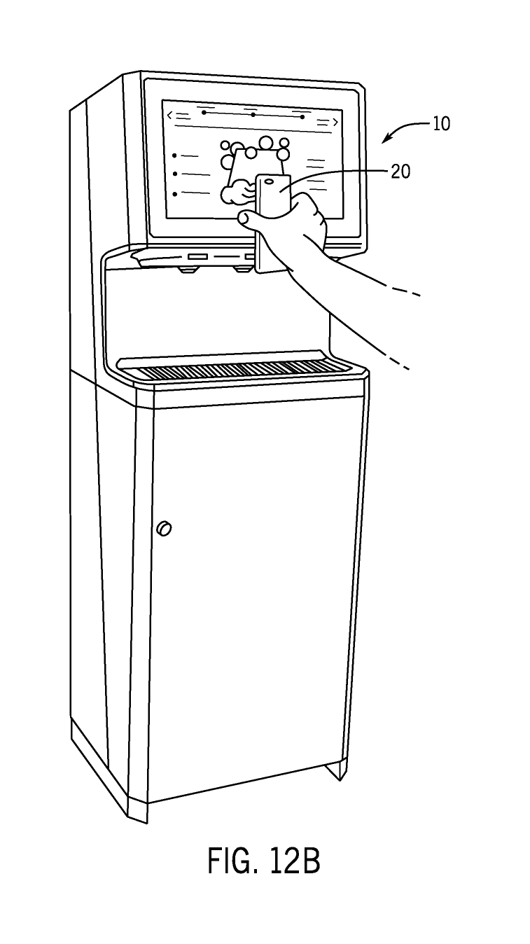

FIGS. 12A and 12B depict an exemplary embodiment of a user inputting an instruction using a barcode on a mobile computing device 20. In the exemplary embodiment depicted, the dispenser 10 includes an auxiliary input device 18, which is exemplarily a bar code reader. The user operates the mobile computing device 20 to present a barcode 34. As shown in FIG. 11B, the user holds the mobile computing device 20 up to the bar code reader 18 to enter the information of the barcode 34 into the dispenser 10 as described herein.

While embodiments described herein have focused on barcodes, the mobile computing device may communicate with the dispenser 10 via barcode or via other communication platforms, including but not limited to near-field communication (NFC), WI-FI, BLUETOOTH, etc. The user could purchase dispensing credits, or connect payment information to the dispenser through the mobile computing device, for example through a coordinated app operating on the mobile computing device. In such embodiments, the app may authorize a particular number of dispenses by the dispenser as credited and paid for by the customer through the app, or the dispenser may “charge” the customer's app for dispenses requested through a communicatively connected dispenser. In an exemplary embodiment, the customer may create the recipe and pay through the app, authorizing the dispense from the dispenser or the customer may pay through the app and then create the recipe through the user interface of the dispenser.

Referring back to FIG. 2, a customer may order and pay through the electronic interface provided by the POS system 120 and the POS system 120 communicates directly with the dispenser 130. Such communication may be wireless or wired communication and may incorporate the use of WI-FI or other communication platforms. In an exemplary embodiment, the POS system 120 includes the checkout computer operated by a restaurant worker or an automated ordering kiosk. While the customer places their order, the customer orders and pays for the dispenses of portions of custom condiments. Once the order is completed, the dispenser 130 is notified of the customer's order and the dispenser is enabled for the dispense.

Coordination of the dispense to the ordering customer may for example be controlled by placement of the dispenser 130 such that the customers are queued in the order that their orders are placed to use the dispenser 130. This coordinates the user's orders with the order in which they arrive at the dispenser 130. In a still further embodiment, the POS system 120 may communicate an order number, which the user selects at the dispenser 130, thus enabling the purchased portions associated with that order number. In another exemplary embodiment, the POS system 120 may capture an image of the customer, for example an image of the customer's face. This image of the customer's face may be associated with the order and the dispenser 130 can be provided with this image and use facial recognition techniques in connection with an auxiliary input device of a digital camera to coordinate the customer with the order and the purchased dispense portions.

In still further exemplary embodiments, aspects of the communication and control as described above respectively between the conveyance device 140 and the dispenser 130 and the POS system 120 and the dispenser 130 may be combined for coordinated operation of the dispenser 130 through the POS system 120 and the conveyance device 140. In an exemplary embodiments, the POS system 120 communicates with the dispenser 130 to provide the dispenser with indications of the actual custom orders of the customers. The conveyance device(s) 140 interact with the dispenser 130 to verify the customer's identity and to connect that customer to a particular order provided by the POS system 120 to the dispenser 130.

For example, a customer places an order into the POS system 120 that includes three portions of custom condiment. The POS system 120 provides an order number or other identifying code/number to the dispenser 130 as described above. The dispenser keeps a queue of all purchased custom condiment orders and the associated identification. The customer is provided with a bar code (on a receipt or portion cup), or pin number, RFID enabled token, tag, or portion cup, or digitally through an app running on a mobile computing device that is read by the dispenser 130 to provide the customer's identification to the dispenser 130. In an exemplary embodiment wherein NFC is used for payment, the payment device may exemplarily communicate the customer's identification back to the mobile device. Upon receiving the customer's identification, the dispenser 130 matches this identification to one of the dispense orders in the queue and if a match is found, then operates to permit the selection and dispense of the custom condiments according to the order. This exemplarily provides both dispense control and verification that the appropriate customer is receiving the purchased condiment portions.

In still further exemplary embodiments, the system 110 may operate to collect information about customers, custom sauce purchases and selected dispenses. This information may be provided to a remotely located server, or to the Cloud, for example through a communicative connection between one or more of the POS system 120, dispenser 130, and conveyance device 140 (e.g. smart phone) via the internet to the server where this information is collected an stored. Data from multiple locations may be aggregated in this form and analyzed to provide insights into customer ordering habits and tastes regarding the condiments ordered and dispensed from the dispenser 130. Exemplary embodiments could also track food items in conjunction with the sauce that was dispensed with them to gather more customer data. These trends could be available via telemetry to the store operator and restaurant chain as a whole. The system may collect itemized order data from the POS and coordinate with the customer's ID code as described in 0084, or the customer's order may be coded into the conveyance device itself. The dispenser may then suggest certain sauce pairings for the types of foods ordered.

In exemplary embodiments wherein the customer pays or verifies their purchase to the dispenser 130 through a mobile computing device, the purchases of the individual customer may be collected and tracked in order to provide the customer with relevant coupons or discounts on future dispenses, or to gain recognition through a loyalty reward program.

Coupons can be provided to the customer when the customer saves a recipe by scanning the QR code after a dispense. The coupon could be presented on the app and could be profiled based on the flavor the user dispensed. For instance, if the user dispensed a spicy barbecue sauce, the coupon could be for another spicy menu item or a dipping food. If the user dispenses a ranch sauce, the coupon may be for a chicken item. If the user dispenses a flavored ketchup, the coupon could be for french fries.

In still further exemplary embodiments, the payment options through an associated app on a mobile computing device may include allowing a user to communicate with another user and possibly allow payment or gifting of a sauce to another user, or even free referrals during product launch.

In exemplary embodiments, in addition to the control and identification as described herein, the bar code (e.g. QR code) could also include specific information about the customer's food order in addition to being a proof-of-payment, so the user interface of the dispenser 130 could display specific or relevant advertising content, as well as recommended sauce pairings. For instance, if the user purchased premium or more gourmet food products, the interface could promote other products in the category. If the user purchased value products, the interface could promote other value deals. In a still further example, knowing the customer's food order, the dispenser 130 may operate to suggest a particular flavor or flavor combination for use on or with the purchased food item or combination of food items.

For example, a promotional sauce may be available with the purchase of a particular food item, the bar code may not only provide the recipe for the promotional sauce, but enable the dispense of the promotional sauce. The dispense of such a promotional sauce may further incorporate the presentation of themed, targeted, or associated advertising. In a non-limiting example, a promotional sauce may be associated with or sponsored by a celebrity or a group. Activation and dispense of the promotional sauce may be accompanied by the presentation of image, audio, and/or video advertising or related content associated with the celebrity or group.

In still further exemplary embodiments, the dispenser may be able to function as a dispenser of basic or base condiments without additional flavoring or customization and do so without further payment or authorization. Likewise in an embodiment of a beverage flavoring dispenser may be operable to dispense basic cream or sweetener on demand, while access to other flavorings or additives require further authorization. In the manners as described herein, the dispenser 130 may operated to accept and verify proof of purchase/payment by customers to activate premium or custom condiment selections and dispenses. For example, cups may be integrated into the dispenser for use of basic condiments, but the user must purchase a flavored condiment cup from the restaurant to activate custom flavor functions.

In another embodiment, the condiment dispenser may also be incorporated into an ordering kiosk as part of the POS system 120. In such embodiment, the user may interact with the device to both place a food and/or drink order, purchase portions of custom sauce, and select and dispense the purchased custom sauce all through a single interface.

In the present Description, certain terms have been used for brevity, clearness, and understanding. No unnecessary limitation are to be implied therefrom beyond the requirement of the prior art because such terms are used for descriptive purposes only and are intended to be broadly construed. The different dispenser apparatuses, systems, and methods described herein may be used alone or in combination with other apparatuses, systems, and methods. Various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of dispensing flavoring, the method comprising:
presenting a plurality of flavoring options on a user interface of a dispenser;
receiving a selection of at least one flavoring option of the plurality of flavoring options;
creating a recipe ID representative of the selected at least one flavoring option; and
dispensing the selected at least one flavoring option.

2. The method of claim 1, in a custom condiment dispenser further comprising:
presenting a plurality of base condiment options on the user interface of the dispenser;
receiving a selection of at least one base condiment option of the plurality of base condiment options; and
dispensing a combined custom condiment by mixing the selected at least one base condiment option with the selected at least one flavoring option;
wherein the recipe ID is further representative of the selected at least one base condiment option.

3. The method of claim 2, wherein the plurality of base condiment options comprises at least one of ketchup, barbeque sauce, ranch, mayonnaise, and mustard.

4. The method of claim 2, wherein the plurality of flavoring options further comprises at least one of sriracha, buffalo, jalapeno, teriyaki, honey, onion, garlic, bacon, oak, soy sauce, smoke, pepper, vinegar, pickle, chili, mint, chocolate, caramel, pumpkin spice, vanilla, egg nog, citrus, peppermint, basil, and/or wasabi.

5. The method of claim 1, further comprising transferring the recipe ID to a computing device.

6. The method of claim 5, wherein transferring the recipe ID comprises sending the recipe ID across a communication network from the condiment dispenser to a third party social media server or a third party email server.

7. The method of claim 5, wherein transferring the recipe ID comprises visually presenting an indication of the recipe ID on the user interface of the condiment dispenser and transferring the recipe ID to a mobile computing device through a camera of the mobile computing device.

8. The method of claim 7, wherein the recipe ID is a quick response (QR) code.

9. The method of claim 1, wherein receiving a selection of at least one of the plurality of flavoring options comprises receiving an input into the dispenser of a recipe ID that represents at least one flavoring option.

10. The method of claim 9, wherein the input is a barcode that encodes the recipe ID and receiving the input comprises reading the barcode with a barcode reader of the dispenser.

11. The method of claim 10, wherein the barcode is a quick response (QR) code.

12. The method of claim 9, wherein the input of the recipe ID is received by the dispenser across a communications network connected to the dispenser.

13. The method of claim 12, wherein the dispenser is communicatively connected to a point of sale (POS) system by the communications network and recipe ID is selected by the user at the POS system.

14. A custom edible substance dispenser comprising:
a graphical display operable to visually present a graphical user interface (GUI), the graphical user interface presenting a plurality of custom dispense options including a plurality of base sauces;
a processor that operates the graphical display to visually present the GUI and the processor receives a user selection of at least one custom dispense option the processor creates a recipe ID representative of the user selection of at least one custom dispense option and operates the graphical display to visually present the recipe ID in the GUI; and
a dispensing system comprising at least one nozzle and operated by the processor to dispense a portion of the custom edible substance with the selected at least one custom dispense option out of the at least one nozzle.

15. The custom edible substance dispenser of claim 14, further comprising an input device that receives an input recipe ID and the processor receives the input recipe ID as the user selection of at least one custom dispense option.

16. The custom edible substance dispenser of claim 15, wherein the input device is a barcode reader.

17. The custom edible substance dispenser of claim 15, wherein the input device is a communication network connection.

18. The custom edible substance dispenser of claim 14, wherein the custom edible substance is a flavoring and the custom dispense option comprise a plurality of flavorings.

19. The custom edible substance dispenser of claim 14, wherein the custom edible substance is a condiment and the custom dispense options comprise a plurality of condiments.

20. The custom edible substance dispenser of claim 19, wherein the custom dispense options comprise a portion size.

21. The custom edible substance dispenser of claim 19, wherein the custom dispense options comprise a plurality of flavorings, the user selection of at least one custom dispense option comprises a selection of at least one condiment and at least one flavoring and the dispensing system is operated by the process to dispense the portion of the at least one condiment and at least one flavoring.

22. A custom edible substance dispensing system comprising:
a point of sale (POS) system that comprises a user interface whereby a user enters a custom order comprising an edible substance with at least one custom dispense option and encodes the custom order as a recipe ID;
a dispenser comprising:
a processor that receives a user selection of at the custom order comprising at least one custom dispense option by receiving the recipe ID; and
a dispensing assembly comprising a plurality of reservoirs containing edible substance and at least one nozzle, the dispensing assembly being operated by the processor to dispense portions of the edible substance of the custom order out of the at least one nozzle; and
a conveyance device communicatively connected to the POS system wherein the conveyance device facilitates transfer of the recipe ID from the POS system to the dispenser.

23. The custom edible substance dispensing system of claim 22, wherein the edible substance is a flavoring and the at least one custom dispense option is a flavoring selection from a plurality of flavorings, the plurality of reservoirs contains a plurality of flavorings, and the processor operates the dispensing assembly to further dispense the selected flavoring.

24. The custom edible substance dispensing system of claim 22, wherein the edible substance is a condiment and the at least one custom dispense option is a condiment selection the plurality of reservoirs contain a plurality of condiments, and the processor operates the dispensing assembly to further dispense the selected condiment.

25. The custom edible substance dispensing system of claim 24, wherein the custom order further comprising at least one flavoring, the dispensing assembly comprises a plurality of reservoirs containing a plurality of flavorings, and the processor operates the dispensing assembly to further dispense the at least one flavoring with the selected condiment.

26. The custom edible substance dispensing system of claim 22, wherein the recipe ID is encoded in a barcode.

27. The custom edible substance dispensing system of claim 26, wherein the conveyance device comprises a barcode printer operable to affix the barcode encoding the recipe ID to a receptacle to receive the custom edible substance.

28. The customer edible substance dispensary system of claim 22, wherein the dispenser further comprises:
a graphical display operable to visually present a graphical user interface (GUI), the graphical user interface presenting a plurality of flavoring options for dispense by the dispenser.
